(19) United States
(12) Patent Application Publication
(10) Pub. No.: US 2023/0060275 A1
(43) Pub. Date: Mar. 2, 2023

(54) ACCELERATING MULTIPLICATIVE MODULAR INVERSE COMPUTATION

(71) Applicant: International Business Machines Corporation, Armonk, NY (US)

(72) Inventor: Rajat RAO, Bangalore (IN)

(21) Appl. No.: 17/407,347

(22) Filed: Aug. 20, 2021

(51) Int. Cl. G06F 7/72

(52) U.S. Cl. CPC G06F 7/721; G06F 7/722

(57) ABSTRACT

Techniques for computing a multiplicative modular inverse of two numbers is described. In the case of a and p, p being an n-bit integer, computing the multiplicative modular inverse includes loading in a first register the value of a, and computing, using a first modular multiplier, a square of the first register n times. Concurrently, using a second modular multiplier, aⁿ is computed. Further, a product of outputs from the first modular multiplier and the second modular multiplier is computed as a result of the multiplicative modular inverse of a and p. In cases where p has more than n bits, the multiplicative modular inverse is computed iteratively using n-bit windows.

### BACKGROUND

The present invention generally relates to computer technology and, more specifically, performing arithmetic operations by implementing a modular exponentiation in a pipelined modular arithmetic unit.

Computers are typically used for applications that perform arithmetic operations. Several applications like cryptography, blockchain, machine learning, image processing, computer games, e-commerce, etc., require such operations to be performed efficiently (e.g., fast). Hence, the performance of integer arithmetic has been the focus of both academic and industrial research.

Several existing techniques are used to improve the performance of the computers, particularly processors and/or arithmetic logic units by implementing the arithmetic instructions to take advantage of, or to adapt the calculation process to the architecture of the hardware. Examples of such techniques include splitting an instruction into multiple operations, where each operation is performed in parallel, two or more operations are combined to reduce memory accesses, the operations are ordered so as to reduce memory access time, storing the operands in a particular order to reduce access time, etc. With applications such as cryptography, machine learning, etc., different types of arithmetic operations can be required. There is a need to adapt operations frequently used by such applications to the hardware so that performance of such operations, and in turn, the applications is improved.

### SUMMARY

Techniques for computing a multiplicative modular inverse of two numbers is described. In the case of a and p, p being an n-bit integer, computing the multiplicative modular inverse includes loading in a first register the value of a, and computing, using a first modular multiplier, a square of the first register n times. Concurrently, using a second modular multiplier, aⁿ is computed. Further, a product of outputs from the first modular multiplier and the second modular multiplier is computed as a result of the multiplicative modular inverse of a and p. In cases where p has more than n bits, the multiplicative modular inverse is computed iteratively using n-bit windows.

In one or more embodiments of the present invention, the first modular multiplier and the second modular multiplier operate concurrently on separate registers. In one or more embodiments of the present invention, the second modular multiplier uses n registers to compute aⁿ.

In one or more embodiments of the present invention, the method further includes storing, by the processing unit, output of the product of outputs from the first modular multiplier and the second modular multiplier in the first register. Further, the processing unit repeats n iterations of computing the square of the first register n times using the first modular multiplier, and computing aⁿ using the second modular multiplier.

In one or more embodiments of the present invention, the first modular multiplier initiates computing the square of the first register from a second iteration before the second modular multiplier completes computing aⁿ from a first iteration.

In one or more embodiments of the present invention, the second modular multiplier completes computing aⁿ from the first iteration before the first modular multiplier completes computing the square of the first register n times.

The above-described features can also be provided at least by a system, a computer program product, and a machine, among other types of implementations.

According to one or more embodiments of the present invention, a system includes a set of registers, and one or more processing units coupled with the set of registers, the one or more processing units comprising a plurality of modular multipliers, wherein the one or more processing units compute a modular multiplicative inverse of a and p, p being an n-bit integer, by performing a method. The method includes loading in a first register, value of a. Further, the method includes computing using a first modular multiplier, a square of the first register n times. Further, the method includes computing concurrently using a second modular multiplier, aⁿ. Further, the method includes computing a product of outputs from the first modular multiplier and the second modular multiplier. Further, the method includes outputting the product as a result of the multiplicative modular inverse of a and p.

According to one or more embodiments of the present invention, a computer program product includes a computer-readable memory that has computer-executable instructions stored thereupon, the computer-executable instructions when executed by one or more processing units cause the one or more processing units to compute a modular multiplicative inverse of a and p, p being an n-bit integer, by performing a method. The method includes loading in a first register, value of a. Further, the method includes computing using a first modular multiplier, a square of the first register n times. Further, the method includes computing concurrently using a second modular multiplier, aⁿ. Further, the method includes computing a product of outputs from the first modular multiplier and the second modular multiplier. Further, the method includes outputting the product as a result of the multiplicative modular inverse of a and p.

In one or more embodiments of the present invention, the multiplicative modular inverse computing is performed in response to receiving an instruction to compute a multiplicative modular inverse of a and Q, wherein Q has more than n bits. The multiplicative modular inverse computing is iterated k=bit−width/n times, wherein a result of an iteration is used as a for a subsequent iteration, and for an i^{th} iteration, the i^{th} set of n bits from Q is used as p.

Embodiments of the present invention provide technical solutions to facilitate a system including arithmetic (multiply/add/sub) units capable of performing modular multiplication in a pipelined way such that a new modular multiplication can be started in less than or equal to half the time the previous multiplication takes to complete. Further, embodiments of the present invention facilitate computing a multiplicative exponentiation using squares and multiplies, where the multiplicand used in the multiply step is computed in parallel with the square step. One or more embodiments of the present invention facilitate creating a lookup table using a window of the exponent to reduce the number of operations dynamically. The lookup table has a storage requirement that scales linearly with the number of operations reduced (bits in window).

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 depicts a block diagram of hardware components of an arithmetic logic unit for computing an exponentiation using a lookup table according to one or more embodiments of the present invention;

FIG. 2 depicts a flowchart of a method for computing multiplicative modular inverse according to one or more embodiments of the present invention;

FIG. 3 depicts a flowchart of a method for computing a multiplicative modular inverse according to one or more embodiments of the present invention with exponent having a bit-width larger than the number of available registers;

FIG. 4 depicts a block diagram of a processor according to one or more embodiments of the present invention; and

FIG. 5 depicts a computing system according to one or more embodiments of the present invention.

The diagrams depicted herein are illustrative. There can be many variations to the diagrams or the operations described therein without departing from the spirit of the invention. For instance, the actions can be performed in a differing order or actions can be added, deleted or modified. Also, the term “coupled” and variations thereof describe having a communications path between two elements and do not imply a direct connection between the elements with no intervening elements/connections between them. All of these variations are considered a part of the specification.

In the accompanying figures and following detailed description of the disclosed embodiments, the various elements illustrated in the figures are provided with two or three-digit reference numbers. With minor exceptions, the leftmost digit(s) of each reference number corresponds to the figure in which its element is first illustrated.

### DETAILED DESCRIPTION

Technical solutions are described herein to accelerate multiplicative modular inverse computation in a pipelined modular arithmetic unit. Computation of the modular multiplicative inverse is an essential step in several fields, such as cryptography. In particular, the RSA (Rivest-Shamir-Adleman) public-key encryption method, uses a pair of numbers that are multiplicative inverses based on a selected modulus, where the pair is used for encrypting and decrypting a message. One of the numbers is made public and is used for encryption, while the other, which is used in the decryption, is maintained private. Determining the private number from the public number is considered to be computationally infeasible, enabling the RSA public-key encryption method to ensure privacy.

Multiplicative modular inverse of an integer a is an integer x such that the product ax is congruent to 1 with respect to the modulus m. This can be expressed as ax≡1(mod m). Stated another way, m divides (evenly) the quantity ax−1, or, in yet another way, the remainder after dividing ax by the integer m is 1. If a does have an inverse modulo m there are an infinite number of solutions of this congruence which form a congruence class with respect to this modulus.

While several techniques for computing the multiplicative modular inverse exists, in computing systems typically two techniques are used: 1) Extended Euclidean algorithm; and 2) Fermat's Little Theorem. The Extended Euclidean algorithm is more popular among the above two. Some existing techniques use what is referred to as the “Chinese Remainder Theorem” to break down large numbers into smaller components and then perform the Extended Euclidean algorithm on the smaller components.

The existing techniques require additional software and/or hardware to control and direct the operations to perform the multiplicative modular inverse. For example, typically, greater than 20% of the hardware units used to perform arithmetic in a computer processor, such as an arithmetic logic unit (ALU), or a modular arithmetic unit (MAU) is dedicated for implementing Extended Euclidean algorithm. Typically, the additional hardware requirement is because the existing approaches use large comparators along with addition/subtraction arithmetic units. Such larger hardware requirement is a technical challenge. In addition, none of these approaches are constant time algorithms. Typically, the existing techniques are performed in O(Log m), for both techniques.

In the case of Fermat's Little Theorem, a pre-condition is that m is a prime number. That is, in the case where Fermat's Little Theorem is used:

a^{m-1}≅1(mod m)→a⁻¹≅a^{m-2}(mod m), if both sides are multiplied with a⁻¹.

The technical solutions described herein use Fermat's Little Theorem to calculate the multiplicative modular inverse. Embodiments of the present invention reduce the hardware and the time taken to compute the inverse.

In addition, computer systems typically use binary number representation when performing arithmetic operations. Further, the computer system, and particularly a processor and an ALU of the processor, have a predefined “width,” “bit-width,” or “word size” (w), for example, 32-bit, 64-bit, 128-bit, etc. The width indicates a maximum number of bits the processor can process at one time. The width of the processor can be dictated by the size of registers, the size of the ALU processing width, or any other such processing limitation of a component associated with the processor.

Further, embodiments of the present invention perform the computation in constant time. That is: 1) For a given prime (p), the computation time of the multiplicative modular inverse for all numbers (<p) is constant; and 2) For a given bit-width, the computation time of the multiplicative inverse for any number modulo a prime of the given bit-width is constant.

Table 1 provides an algorithm/pseudo-code for computing an exponentiation using square and multiply operations only. The exponentiation operation is required for computing the multiplicative modular inverse by embodiments of the present invention.

TABLE 1
Algorithm 1 Square-and-multiply

| Require: x ∈ {0, . . . , N − 1} and K = (kₗ₋₁, . . . , k₀)₂ | |
|---|---|
| 1: | r ← 1 |
| 2: | for i from l − 1 downto 0 do |
| 3: | r ← r² mod N |
| 4: | if kᵢ = 1 then |
| 5: | r ← r × x mod N |
| 6: | end if |
| 7: | end for |
| 8: | return r |

Consider using a precomputation-based lookup table that computes powers of the number a to be used for 4-bits of the exponent x. For the 4-bit exponent case, to determine the result of a^{1·x}^{₁}^{·x}^{₂}^{·x}^{₃}^{x}^{₄}, requires a lookup table to have all the values a, a², a³, . . . a¹⁵ precomputed and stored. Every 4-bits of exponent require 16 entries in the lookup table. The exponential nature means that typical implementations create a lookup table of no more than 16 or 32 entries. It is understood that in other examples, a different number of bits can be used for the exponent x, requiring different number of entries in the lookup table.

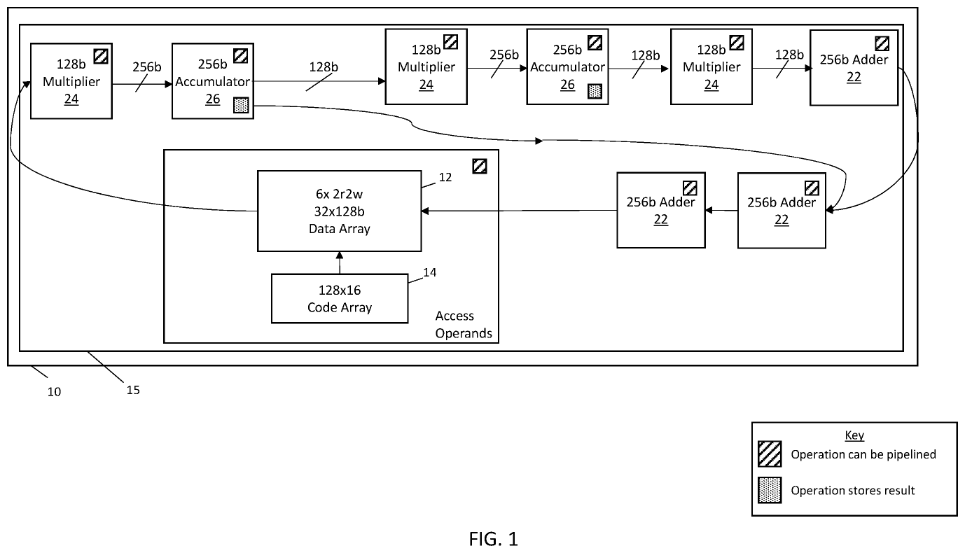

FIG. 1 depicts a block diagram of hardware components of an ALU 15 for computing the exponentiation using a lookup table 12. The ALU 15 can be part of a processor 10. In FIG. 1 one or more components that are depicted, can use pipelining to improve efficiency of computation in one or more embodiments of the present invention. Further, in some embodiments of the present invention, result(s) of one or more components depicted can be stored, for example, in memory, in registers, etc., as intermediate values. The components that store intermediate (or final) results are also identified in FIG. 1.

The components of the ALU 15 include one or more instances of adders 22, multipliers 24, and accumulators 26. FIG. 1 also depicts a code array 14 that includes the instructions to be executed, including the operands that are to be used for the multiplicative modular inverse. The lookup table 12 is also shown that stores the precomputed values to be used during the multiplicative modular inverse computation, particularly for the exponentiation operation.

Further, FIG. 1 depicts bit-widths (e.g., 128b, 256b) of the one or more components in the ALU 15, as well as the width of data transferred from one component to the other during the computations. It is understood that the bit-widths can be varied in one or more embodiments of the present invention. Table 2 depicts performance of existing techniques, in number of clock cycles required, to compute a multiplicative modular inverse for different widths of the prime (a).

TABLE 2

Multiplicative Modular Inverse

| | | Iteration |
|---|---|---|
| Prime Width | Latency | Interval (II) |
| 64-bit | 21 | 1 |
| 128-bit | 21 | 1 |
| 256-bit | 25 | 5 |
| 384-bit | 30 | 10 |
| 512-bit | 37 | 17 |

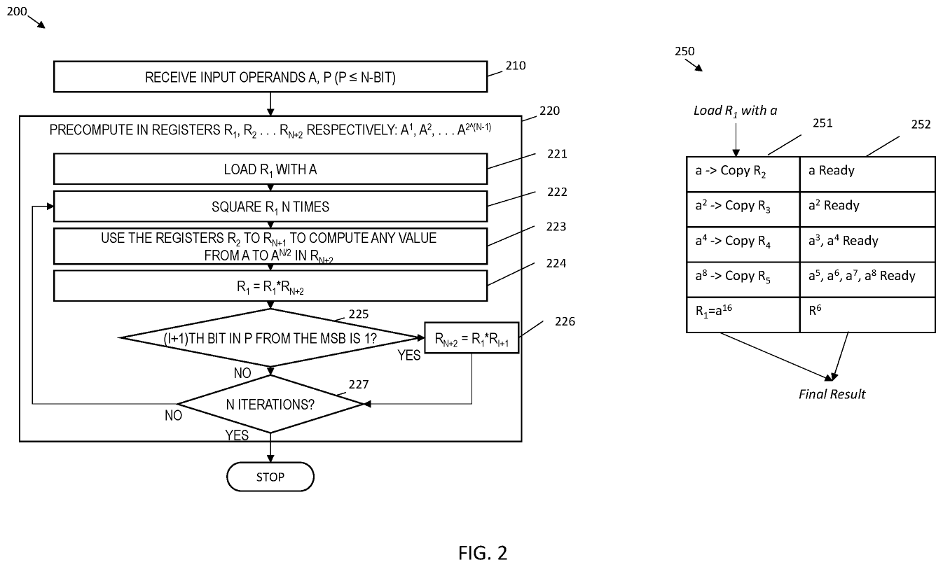

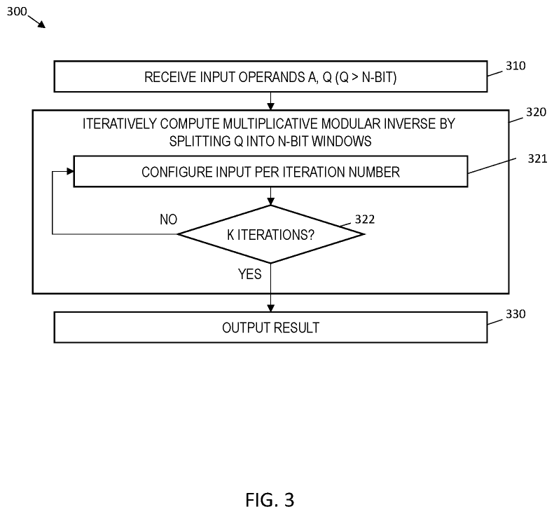

FIG. 2 depicts a flowchart of a method for computing multiplicative modular inverse according to one or more embodiments of the present invention. The method 200 that is depicted can be used for any arbitrary a, which can be reduced modulo p before computing the inverse. Method 200 is shown for a p that is has maximum n bits. FIG. 3 depicts a method 300 for computing the multiplicative modular inverse for p with ‘n+1’ or more bits. Here n is the number of registers available to use for the calculations. As will be understood and demonstrated by the description herein, the acceleration provided by one or more embodiments of the present invention in computing the multiplicative modular inverse is greater for larger p (i.e., more bit-width of p).

In the depicted method 200, the exponent p has at most n-bits, where n is the number of available registers. Table 250 depicts an execution of the method 200 for a 4-bit exponent.

Method 200 includes receiving the operands a and p for computing the multiplicative modular inverse, at block 210. The operand p is n-bit in the example herein, and hence a single iteration is described. The iteration is repeated for larger numbers as is described elsewhere in context of FIG. 3. The operands can be provided as part of an instruction, such as a machine-level executable instruction (“assembly code”) that includes an opcode and the operands. The opcode is specific to the multiplicative modular inverse computation. The operands a and p can be specified as immediate values, register names that are storing the values, memory locations that are storing the values, etc., or a combination thereof.

At block 220, intermediate values to compute the values a, a², . . . , a^{2\hat{ }(n-1)} in an efficient manner are precomputed and stored in registers R₁, R₂, . . , Rₙ₊₂, respectively (e.g., for n=4, the last power needed is a^{2\hat{ }3=8}). The precomputation includes loading a first register, R₁ with a, at block 221.

At block 222, a squaring operation is performed on register R₁ (i.e., R₁=R₁*R₁) n times. At block 223, a^{p-1-2\hat{ }n} is computed, accordingly enabling the registers R₂ to Rₙ₊₁ together with the n bits of the exponent (p) to be used to compute any value from a to a^{n/2} in the register Rₙ₊₂. Further, at block 224, the multiplication R₁=R_{1.}Rₙ₊₂ is computed. For example, if p=31, n=4, then at block 223, a¹⁴ (p−1−2\hat{ }n=31−1−2\hat{ }4=30−16=14) is computed which will be combined with a¹⁶ as shown in step 224 to get a³⁰.

The above operations (222, 223, and 224) are repeated until it is determined that n iterations have been completed, at block 227. Prior to that, at blocks 225 and 226, a multiplication Rₙ₊₂=R₁*Rᵢ₊₁ is performed in the i^{th} iteration, and where the multiplication is conditionally performed, only if the (i+1)^{th} bit in p from the MSB is 1.

Table 250 in FIG. 2 shows the potential values available in the registers R₁-R₅ at the end of each iteration in the case where n=4. Four additional registers R₂-R₅ facilitate a 16-value lookup at the final step (i.e., 224). The first column 251 indicates the value in the register R1 after each squaring operation (see 222), which is then stored in other register (e.g., R2, R3, etc.). The second column 252 identifies what powers can be computed at a given step using a single operation using the values that are stored in the registers, as well as in R1. Determination of which of the powers are computed is based on the conditional logic (e.g., see 225, 227).

Referring to the flowchart of method 200 in FIG. 2, the square-and-multiply algorithm is mapped to a pipelined hardware so that the time taken by operations of block 222 is completely hidden by the operations of block 223. Or in other words, the operations in block 222 and block 223 are performed in parallel.

In one or more embodiments of the present invention, the operations in 222 are performed in parallel using a first modular multiplicative unit and the operations in 223 are performed by a second modular multiplicative unit. The output from both these operations are then multiplied by either one of the modular multiplicative units, or by a typical multiplier. Here, the value in register R1 is the final multiplicative modular inverse at this time. Alternatively, if the input exponent has more than n bits, the value in R1 is a partial result for a subsequent iteration because, the method 200 processes only n bits (n=number of available registers) at a time. In this case, the value in R1 is input to the next iteration.

Accordingly, the only additional time apart from squaring is the multiplication in the block 224. Hence, the

$$total time for computing the multiplicative modular inverse = ( {t}_{s q} + \frac{{t}_{m u l}}{n} ) \cdot ⌈ {log}_{2} ( exp ) ⌉ ,$$

where t_{sq} is the time for computing the squares, and tₘᵤₗ is the time for computing the multiplication. Also, because the described scheme only requires n registers, the value of n can be chosen to be 32 (or as available registers).

Thus, embodiments of the present invention facilitate calculating the multiplicative modular inverse using only modular multiplier units and a 1-bit comparator. In other words, large comparators are not required, and conditional processing hardware/software code is also not required. Accordingly, the multiplicative modular inverse calculation can be performed in constant time as provided by Table 3. As seen, embodiments of the present invention provide a significant speedup over existing, non-pipelined techniques.

| | | Speedup Over non- |
|---|---|---|
| Prime | Clocks | pipelined multiplier |
| Generic 128-bit | 2816 | 93% |
| Generic 256-bit | 6400 | 93% |
| Generic 512-bit | 18944 | 93% |
| Generic 768-bit | 87552 | None |

Technical solutions described herein accordingly facilitate techniques to perform modular exponentiation on a pipelined modular multiplication unit by dynamically creating the lookup entry required using a storage, where the storage required is linear in number of bits being looked up. Further, the technical solutions described herein facilitate the multiplicative modular inverse to complete in constant-time. This improvement is substantial in specific applications such as cryptography, because the constant time execution facilitates preventing leaks of side-channel information on the number a or the exponent x.

Additionally, for a case with at least 32 registers available, the time taken by the technical solutions described herein reduces by 93% compared to existing constant-time implementation(s) and by 45% on average compared to non-constant time implementation(s).

FIG. 3 depicts a method 300 for computing a multiplicative modular inverse according to one or more embodiments of the present invention. As noted herein, FIG. 2 depicts the method 200 that facilitates embodiments of the present invention to operate on a single n bit window at a time because the registers might limit the concurrency in the calculation described herein. Method 300 of FIG. 3 facilitates embodiments of the present invention to provide accelerated computation of the multiplicative modular inverse for an arbitrary a and an exponent Q that has more than n bits, n being the number of registers available for the computation.

The input values, a and Q, are received at block 310. As noted, Q has more than n bits, n being the number of available registers in the processing unit being used to compute the multiplicative modular inverse. It should be noted that “available registers” can be the total number of registers in the processing unit in one or more embodiments of the present invention. Alternatively, or in addition, in one or more embodiments of the present invention, “available registers” can be a subset of the total number of registers of the processing unit, where only that subset is free to be used for the multiplicative modular inverse computation.

At block 320, the method 200 is performed iteratively to compute the multiplicative modular inverse by splitting Q into n-bit windows. For each iteration the input values, a and p, of the method 200 are configured based on the iteration number (i), at block 321.

In each i^{th} iteration, the i^{th} set of n bits from Q is used as the input value p of the method 200. For example, for the 256-bit Q, and n=32 registers, i=1^{st} iteration uses bits 1-32 of Q as p; i=2^{nd} iteration uses bits 33-64 of Q as p; i=3^{rd} iteration uses bits 65-96 of Q as p; and so on. For the first iteration, the input a is loaded as the starting input value. For the second iteration, the output from the first iteration is loaded as the starting value (instead of a). In other words, the multiple iterations are performed in a sequential manner with the input values, a and p, being updated in each iteration. The result of the final iteration is the final result of the requested/instructed multiplicative modular inverse computation, at block 330.

The method 200 is repeated k=bit−width/n times, at block 322, where bit-width is the number of bits of Q. For example, for a 256-bit number Q (i.e., bit-width of Q is 256) and a computing unit having 32 available registers (i.e., n=32), the method 200 is executed 256/32=8 times.

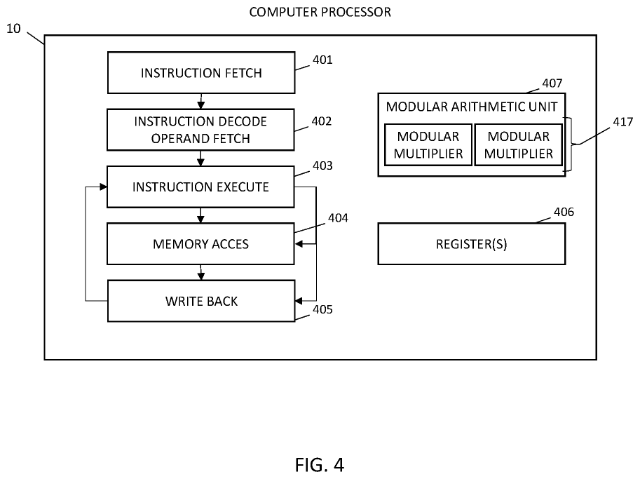

FIG. 4 depicts a block diagram of a processor according to one or more embodiments of the present invention. The processor 10 can include, among other components, an instruction fetch unit 401, an instruction decode operand fetch unit 402, an instruction execution unit 403, a memory access unit 404, a write back unit 405, a set of registers 406, and a modular arithmetic unit 407. In one or more embodiments of the present invention, the modular multiplicative unit 407 can be part of an arithmetic logic unit (ALU) (not shown).

In one or more embodiments of the present invention, the modular arithmetic unit 407 includes two or more modular multipliers 417 that can be operated in parallel. For example, a first modular multiplier 417 can be instructed to perform a first multiplication (e.g., squaring (block 222)), and a second modular multiplier 417 can be instructed to perform a second multiplication (e.g., computing aⁿ (block 223)), before the first modular multiplier 417 has completed its operation. The first modular multiplier 417 and the second modular multiplier 417 operate concurrently. In one or more embodiments of the present invention, the concurrence is achieved by using separate operands (e.g., registers) for the two modular multipliers 417. Herein, two operations are performed “concurrently” when there is at least some overlap between the execution of the two operations.

In one or more embodiments of the present invention, the processor 10 can be one of several computer processors in a processing unit, such as a central processing unit (CPU), a graphics processing unit (GPU), a tensor processing unit (TPU), or any other processing unit of a computer system. Alternatively, or in addition, the processor 10 can be a computing core that is part of one or more processing units.

The instruction fetch unit 401 is responsible for organizing program instructions to be fetched from memory, and executed, in an appropriate order, and for forwarding them to the instruction execution unit 403. The instruction decode operand fetch unit 402 facilitates parsing the instruction and operands, e.g., address resolution, pre-fetching, prior to forwarding an instruction to the instruction execution unit 403. The instruction execution unit 403 performs the operations and calculations as per the instruction. The memory access unit 404 facilitates accessing specific locations in a memory device that is coupled with the processor 10. The memory device can be a cache memory, a volatile memory, a non-volatile memory, etc. The write back unit 405 facilitates recording contents of the registers 406 to one or more locations in the memory device. The modular arithmetic unit 407 facilitates improving the performance of the multiplicative modular inverse computation as described herein.

It should be noted that the components of the processors can vary in one or more embodiments of the present invention without affecting the features of the technical solutions described herein. In some embodiments of the present invention, the components of the processor 10 can be combined, separated, or different from those described herein.

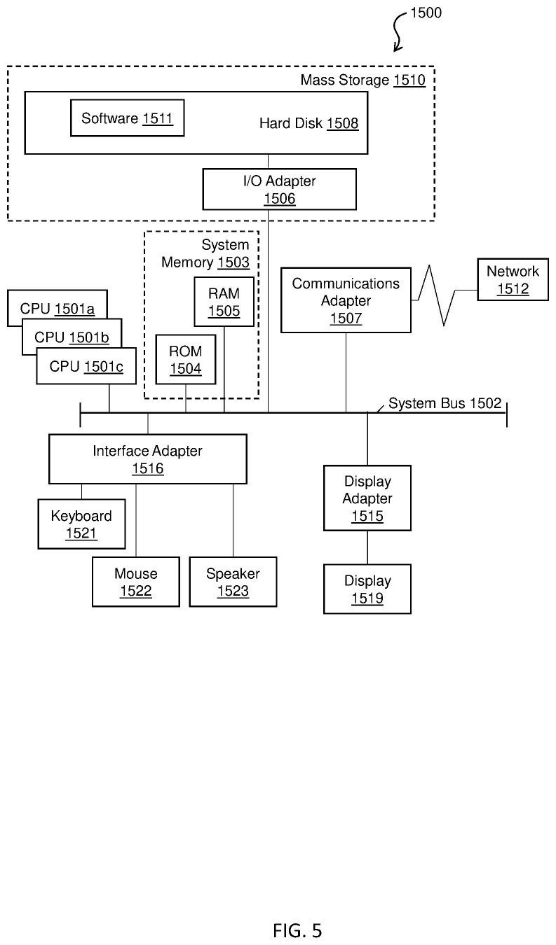

Turning now to FIG. 5, a computer system 1500 is generally shown in accordance with an embodiment. The computer system 1500 can be a target computing system being used to perform one or more functions that require a masked shift add operation to be performed. The computer system 1500 can be an electronic, computer framework comprising and/or employing any number and combination of computing devices and networks utilizing various communication technologies, as described herein. The computer system 1500 can be easily scalable, extensible, and modular, with the ability to change to different services or reconfigure some features independently of others. The computer system 1500 may be, for example, a server, desktop computer, laptop computer, tablet computer, or smartphone. In some examples, computer system 1500 may be a cloud computing node. Computer system 1500 may be described in the general context of computer system executable instructions, such as program modules, being executed by a computer system. Generally, program modules may include routines, programs, objects, components, logic, data structures, and so on that perform particular tasks or implement particular abstract data types. Computer system 1500 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, the computer system 1500 has one or more central processing units (CPU(s)) 1501a, 1501b, 1501c, etc. (collectively or generically referred to as processor(s) 1501). The processors 1501 can be a single-core processor, multi-core processor, computing cluster, or any number of other configurations. The processors 1501, also referred to as processing circuits, are coupled via a system bus 1502 to a system memory 1503 and various other components. The system memory 1503 can include a read only memory (ROM) 1504 and a random access memory (RAM) 1505. The ROM 1504 is coupled to the system bus 1502 and may include a basic input/output system (BIOS), which controls certain basic functions of the computer system 1500. The RAM is read-write memory coupled to the system bus 1502 for use by the processors 1501. The system memory 1503 provides temporary memory space for operations of said instructions during operation. The system memory 1503 can include random access memory (RAM), read only memory, flash memory, or any other suitable memory systems.

The computer system 1500 comprises an input/output (I/O) adapter 1506 and a communications adapter 1507 coupled to the system bus 1502. The I/O adapter 1506 may be a small computer system interface (SCSI) adapter that communicates with a hard disk 1508 and/or any other similar component. The I/O adapter 1506 and the hard disk 1508 are collectively referred to herein as a mass storage 1510.

Software 1511 for execution on the computer system 1500 may be stored in the mass storage 1510. The mass storage 1510 is an example of a tangible storage medium readable by the processors 1501, where the software 1511 is stored as instructions for execution by the processors 1501 to cause the computer system 1500 to operate, such as is described herein below with respect to the various Figures. Examples of computer program product and the execution of such instruction is discussed herein in more detail. The communications adapter 1507 interconnects the system bus 1502 with a network 1512, which may be an outside network, enabling the computer system 1500 to communicate with other such systems. In one embodiment, a portion of the system memory 1503 and the mass storage 1510 collectively store an operating system, which may be any appropriate operating system, such as the z/OS or AIX operating system from IBM Corporation, to coordinate the functions of the various components shown in FIG. 5.

Additional input/output devices are shown as connected to the system bus 1502 via a display adapter 1515 and an interface adapter 1516 and. In one embodiment, the adapters 1506, 1507, 1515, and 1516 may be connected to one or more I/O buses that are connected to the system bus 1502 via an intermediate bus bridge (not shown). A display 1519 (e.g., a screen or a display monitor) is connected to the system bus 1502 by a display adapter 1515, which may include a graphics controller to improve the performance of graphics intensive applications and a video controller. A keyboard 1521, a mouse 1522, a speaker 1523, etc. can be interconnected to the system bus 1502 via the interface adapter 1516, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 5, the computer system 1500 includes processing capability in the form of the processors 1501, and, storage capability including the system memory 1503 and the mass storage 1510, input means such as the keyboard 1521 and the mouse 1522, and output capability including the speaker 1523 and the display 1519.

In some embodiments, the communications adapter 1507 can transmit data using any suitable interface or protocol, such as the internet small computer system interface, among others. The network 1512 may be a cellular network, a radio network, a wide area network (WAN), a local area network (LAN), or the Internet, among others. An external computing device may connect to the computer system 1500 through the network 1512. In some examples, an external computing device may be an external webserver or a cloud computing node.

It is to be understood that the block diagram of FIG. 5 is not intended to indicate that the computer system 1500 is to include all of the components shown in FIG. 5. Rather, the computer system 1500 can include any appropriate fewer or additional components not illustrated in FIG. 5 (e.g., additional memory components, embedded controllers, modules, additional network interfaces, etc.). Further, the embodiments described herein with respect to computer system 1500 may be implemented with any appropriate logic, wherein the logic, as referred to herein, can include any suitable hardware (e.g., a processor, an embedded controller, or an application specific integrated circuit, among others), software (e.g., an application, among others), firmware, or any suitable combination of hardware, software, and firmware, in various embodiments.

The present invention may be a system, a method, and/or a computer program product at any possible technical detail level of integration. The computer program product may include a computer-readable storage medium (or media) having computer-readable program instructions thereon for causing a processor to carry out aspects of the present invention.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present invention may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language such as Smalltalk, C++, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method comprising:
computing, by a processing unit, a multiplicative modular inverse of a and p, p being an n-bit integer, the computing comprising:
loading, by the processing unit, in a first register, value of a;
computing, by the processing unit, using a first modular multiplier, a square of the first register n times;
computing, by the processing unit, concurrently, using a second modular multiplier, aⁿ;
computing, by the processing unit, a product of outputs from the first modular multiplier and the second modular multiplier; and
outputting, by the processing unit, the product as a result of the multiplicative modular inverse of a and p.

2. The computer-implemented method of claim 1, wherein the first modular multiplier and the second modular multiplier operate concurrently on separate registers.

3. The computer-implemented method of claim 2, wherein the second modular multiplier uses n registers to compute aⁿ.

4. The computer-implemented method of claim 1, further comprising:
storing, by the processing unit, output of the product of outputs from the first modular multiplier and the second modular multiplier in the first register; and
repeating, by the processing unit, n iterations of:
computing the square of the first register n times using the first modular multiplier, and
computing aⁿ using the second modular multiplier.

5. The computer-implemented method of claim 4, wherein the first modular multiplier initiates computing the square of the first register from a second iteration before the second modular multiplier completes computing aⁿ from a first iteration.

6. The computer-implemented method of claim 5, wherein the second modular multiplier completes computing aⁿ from the first iteration before the first modular multiplier completes computing the square of the first register n times.

7. The computer-implemented method of claim 1, wherein the computing is performed in response to receiving an instruction to compute a multiplicative modular inverse of a and Q, and wherein computing the multiplicative modular inverse is iterated k=bit−width/n times, wherein a result of an iteration is used as a for a subsequent iteration, and for an i^{th} iteration, the i^{th} set of n bits from Q is used as p.

8. A system comprising:
a set of registers; and
one or more processing units coupled with the set of registers, the one or more processing units comprising a plurality of modular multipliers, wherein the one or more processing units are configured to compute a modular multiplicative inverse of a and p, p being an n-bit integer, by performing a method that comprises:
loading in a first register, value of a;
computing using a first modular multiplier, a square of the first register n times;
computing concurrently using a second modular multiplier, aⁿ;
computing a product of outputs from the first modular multiplier and the second modular multiplier; and
outputting the product as a result of the multiplicative modular inverse of a and p.

9. The system of claim 8, wherein the first modular multiplier and the second modular multiplier operate concurrently on separate registers.

10. The system of claim 9, wherein the second modular multiplier uses n registers to compute aⁿ.

11. The system of claim 8, wherein the method further comprises:
storing, by the one or more processing units, output of the product of outputs from the first modular multiplier and the second modular multiplier in the first register; and
repeating, by the one or more processing units, n iterations of:
computing the square of the first register n times using the first modular multiplier, and
computing aⁿ using the second modular multiplier.

12. The system of claim 11, wherein the first modular multiplier initiates computing the square of the first register from a second iteration before the second modular multiplier completes computing aⁿ from a first iteration.

13. The system of claim 12, wherein the second modular multiplier completes computing aⁿ from the first iteration before the first modular multiplier completes computing the square of the first register n times.

14. The system of claim 8, wherein the multiplicative modular inverse is used for cryptography.

15. A computer program product comprising a computer-readable memory that has computer-executable instructions stored thereupon, the computer-executable instructions when executed by one or more processing units cause the one or more processing units to compute a modular multiplicative inverse of a and p, p being an n-bit integer, by performing a method that comprises:
loading in a first register, value of a;
computing using a first modular multiplier, a square of the first register n times;
computing concurrently using a second modular multiplier, aⁿ;
computing a product of outputs from the first modular multiplier and the second modular multiplier; and
outputting the product as a result of the multiplicative modular inverse of a and p.

16. The computer program product of claim 15, wherein the first modular multiplier and the second modular multiplier operate concurrently on separate registers.

17. The computer program product of claim 15, wherein the method further comprises:
storing, by the one or more processing units, output of the product of outputs from the first modular multiplier and the second modular multiplier in the first register; and
repeating, by the one or more processing units, n iterations of:
computing the square of the first register n times using the first modular multiplier, and
computing aⁿ using the second modular multiplier.

18. The computer program product of claim 17, wherein the first modular multiplier initiates computing the square of the first register from a second iteration before the second modular multiplier completes computing aⁿ from a first iteration.

19. The computer program product of claim 18, wherein the second modular multiplier completes computing aⁿ from the first iteration before the first modular multiplier completes computing the square of the first register n times.

20. The computer program product of claim 15, wherein, in response to receiving an instruction to compute the multiplicative modular inverse of a and Q, Q having more than n bits, splitting Q into n-bit windows, and iteratively computing the multiplicative modular inverse, an i^{th} iteration using the i^{th} set of n bits from Q as p.
